(19) United States
(12) Patent Application Publication
(10) Pub. No.: US 2005/0108695 A1
(43) Pub. Date: May 19, 2005

(54) Apparatus and method for an automatic thread-partition compiler

(76) Inventors: Long Li, Shanghai (CN); Cotton Seed, Cambridge, MA (US); Bo Huang, Shanghai (CN); Luddy Harrison, Chestnut, MA (US); Jinquan Dai, Shanghai (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/714,198

(22) Filed: Nov. 14, 2003

(51) Int. Cl. G06F 9/45

(52) U.S. Cl. 717/144

(57) ABSTRACT

In some embodiments, a method and apparatus for an automatic thread-partition compiler are described. In one embodiment, the method includes the transformation of a sequential application program into a plurality of application program threads. Once partitioned, the plurality of application program threads are concurrently executed as respective threads of a multi-threaded architecture. Hence, a performance improvement of the parallel multi-threaded architecture is achieved by hiding memory access latency through or by overlapping memory access with computations or with other memory accesses. Other embodiments are described and claimed.

### FIELD OF THE INVENTION

One or more embodiments of the invention relate generally to the field of multi-thread micro-architectures. More particularly, one or more of the embodiments of the invention relates to a method and apparatus for an automatic thread-partition compiler.

### BACKGROUND OF THE INVENTION

Hardware multi-threading is becoming a practical technique in the modern processor design. Several multi-threaded processors have already been announced in the industry or are in production in the areas of high-performance computing, multi-media processing and network packet processing. The Internet exchange processor (IXP) series, which belong to the Intel® Internet Exchange™ Architecture (IXA) Network Processor (NP) family, are such examples of multi-threaded processors. In general, each IXP includes a highly parallel, multi-threaded architecture in order to meet the high-performance requirements of packet processing.

Generally, NPs are specifically designed to perform packet processing. Conventionally, NPs may be used to perform such packet processing as a core element of high-speed communication routers. Generally, traditional network applications for performing packet processing are conventionally coded using sequential semantics. Generally, such network applications are coded to use a unit of packet processing (a packet processing stage (PPS)) that runs forever. Hence, when a new packet arrives, the PPS performs a series of tasks (e.g., receipt of the packet, routing table look-up and enqueuing of the packet). Consequently, a PPS is usually expressed as an infinite loop (or a PPS loop) with each iteration processing a different packet.

Hence, in spite of the highly parallel, multi-threaded architecture provided by modern NPs, failure to exploit such parallelism results in highly unused processor resources. Undoubtedly, poor performance gain can be achieved if a sequential application program runs on top of the advance multi-threaded architectures provided by NPs. In order to achieve high-performance, programmers have tried to fully utilize the multi-threaded architecture provided by NPs by exploiting the thread level parallelism of sequential applications. Unfortunately, manually threaded partitioning is a challenge for most programmers.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system having a thread partition compiler, in accordance with one embodiment of the invention.

FIGS. 2A-2C depict transformation of a sequential packet processing stage (PPS) into two application program threads, in accordance with one embodiment of the invention.

FIGS. 3A-3B illustrate transformation of a sequence of a sequential PPS loop, including critical sections surrounded by one or more boundary instructions, in accordance with one embodiment of the invention.

FIG. 4 is a block diagram illustrating a processor, including a multi-threaded architecture, in accordance with one embodiment of the invention.

FIG. 5 is a block diagram illustrating a method for thread partitioning a loop body of a sequential application program, in accordance with one embodiment of the invention.

FIGS. 6A-6B are diagrams illustrating formation of a control flow graph (CFG loop), in accordance with one embodiment of the invention.

FIG. 7 is a flowchart illustrating a method for modifying a CFG loop enclosing identified critical sections within pairs of boundary instructions, in accordance with one embodiment of the invention.

FIG. 8 is a flowchart illustrating a method for reducing an amount of instructions between corresponding pairs of boundary instructions, in accordance with one embodiment of the invention.

FIG. 9 is a flowchart illustrating a method for hoisting motion candidate instructions, in accordance with one embodiment of the invention.

FIG. 10 is a block diagram illustrating a flow dependence graph, in accordance with one embodiment of the invention.

FIG. 11 is a flowchart illustrating a method for hoisting motion candidate instructions, in accordance with one embodiment of the invention.

FIG. 12 is a flowchart illustrating a method for sinking motion candidate instructions, in accordance with one embodiment of the invention.

FIG. 13 is a flowchart illustrating a method for sinking motion candidate instructions, in accordance with one embodiment of the invention.

FIG. 14 is a flowchart illustrating a method for hoisting motion candidate instructions, in accordance with one embodiment of the invention.

FIGS. 15A and 15B are block diagrams, illustrating computation of motion candidates, in accordance with one embodiment of the invention.

FIG. 16 is a flowchart illustrating a method for partitioning a sequential application program into a plurality of application program threads for concurrent execution of the program threads, in accordance with one embodiment of the invention.

### DETAILED DESCRIPTION

A method and apparatus for an automatic thread-partition compiler are described. In one embodiment, the method includes the transformation of a sequential application program into a plurality of application program threads. Once partitioned, the plurality of application program threads are concurrently executed as respective threads of a multi-threaded architecture. Hence, a performance improvement of the parallel multi-threaded architecture is achieved by hiding memory access latency through or by overlapping memory access with computations or with other memory accesses.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logical. The integrated circuit may take the form of a processor such as a microprocessor, application specific integrated circuit, a digital signal processor, a micro-controller, or the like.

An example of “software” includes executable code in the form of an application, an applet, a routine or even a series of instructions. The software may be stored in any type of computer or machine readable medium such as a programmable electronic circuit, a semiconductor memory device inclusive of volatile memory (e.g., random access memory, etc.) and/or non-volatile memory (e.g., any type of read-only memory “ROM,” flash memory), a floppy diskette, an optical disk (e.g., compact disk or digital video disk “DVD”), a hard drive disk, tape, or the like.

In one embodiment, the present invention may be provided as an article of manufacture which may include a machine or computer-readable medium having stored thereon instructions which may be used to program a computer (or other electronic devices) to perform a process according to one embodiment of the present invention. The computer-readable medium may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

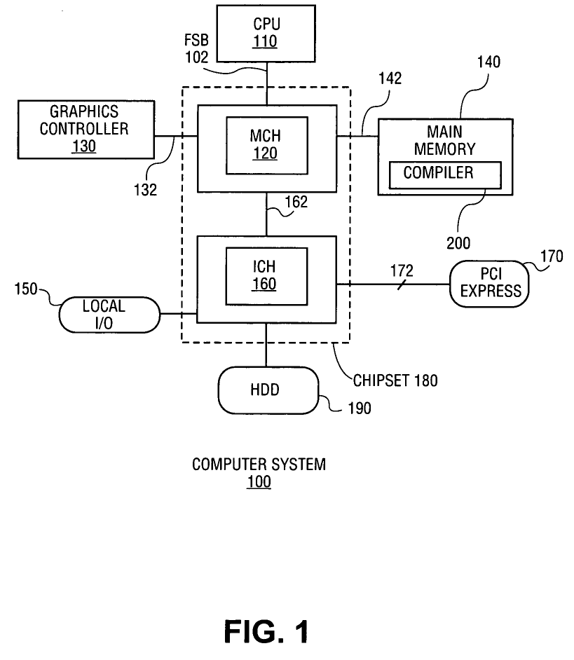

FIG. 1 is a block diagram illustrating a computer system 100 including a thread-partition compiler 200, in accordance with one embodiment of the invention. As illustrated, computer system 100 includes a CPU 110, memory 140 and graphics controller 130 coupled to memory controller hub (MCH) 120. As described herein, MCH 120 may be referred to as a north bridge and, in one embodiment, as a memory controller. In addition, computer system 100 includes I/O (input/output) controller hub (ICH) 160. As described herein ICH 160 may be referred to as a south bridge or an I/O controller. South bridge, or ICH 160, is coupled to local I/O 150 and hard disk drive devices (HDD) 190.

In the embodiment illustrated, ICH 160 is coupled to I/O bus 172 which couples a plurality of I/O devices, such as, for example, PCI or peripheral component interconnect (PCI) devices 170, including PCI-express, PCI-X, third generation I/O (3GIO), or other like interconnect protocol. Collectively, MCH 120 and ICH 160 are referred to as chipset 180. As is described herein, the term “chipset” is used in a manner well known to those skilled in the art to describe, collectively, the various devices coupled to CPU 110 to perform desired system functionality. In one embodiment, main memory 140 is volatile memory including, but not limited to, random access memory (RAM), synchronous RAM (SRAM), dynamic RAM (DRAM), synchronous DRAM (SDRAM), double data rate (DDR) SDRAM (DDR SDRAM), Rambus DRAM (RDRAM), direct RDRAM (DRDRAM), or the like.

System

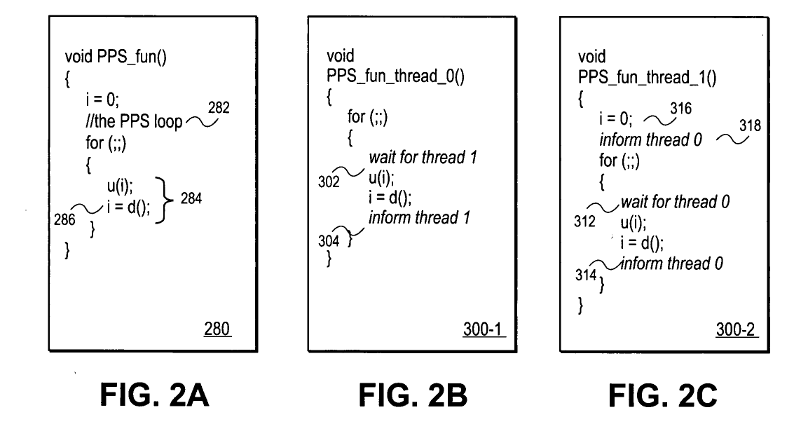

In contrast to conventional computer systems, computer system 100 includes thread partitioning compiler 200 for partitioning a sequential application program into a plurality of application program threads (“thread-partitioning”). Hence, compiler 200 may bridge the gap between the multi-threaded architecture of network processors and the sequential programming model used to code conventional network applications. One way to address this problem is to exploit the thread level parallelism of sequential applications. Unfortunately, manually thread-partitioning a sequential application is a challenge for most programmers. In one embodiment, thread-partition compiler 200 is provided for automatically thread-partitioning a sequential network application, as illustrated in FIG. 2A, into a plurality of program threads, as illustrated in FIGS. 2B-2C.

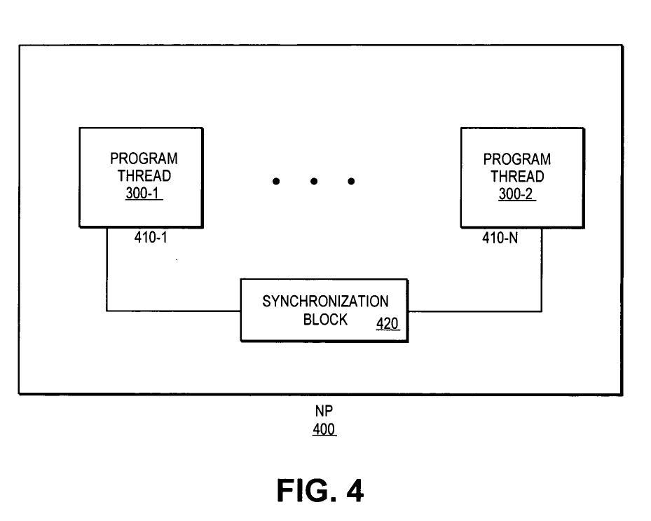

Referring to FIG. 2A, a sequential packet processing stage (PPS) 280 of a sequential network application is illustrated. In one embodiment, PPS 280 is transformed into a first program thread 300-1 (FIG. 2B) and a second program thread 300-2 (FIG. 2C) for execution within, for example, a multi-threaded network processor 400 of FIG. 4. In one embodiment, performance of a multi-threaded architecture is improved by transforming a traditional network application, as illustrated with reference to FIG. 2A, into multiple program-threads, as illustrated with reference to FIGS. 2B-2C.

In one embodiment, a sequential PPS infinite loop 282 is transformed into multiple program-threads (300-1, 300-2) with optimized synchronization between the program-threads to achieve improved parallel execution. Unfortunately, sequential PPS loops (e.g., 282) include the sequential execution of dependent operations including, for example, loop carried variables. As described herein, a loop carried variable is a data dependent relation from one iteration to another iteration of a loop. In one embodiment, a loop carried variable includes two properties: (i) the loop carried variable is alive on the back edge of a PPS loop of the sequential PPS; and (ii) the value of the loop carried variable is changed in the PPS loop body. Representatively, the variable i 286 represents a loop carried variable within a critical section 284 of PPS loop 282, as is described in further detail below.

In one embodiment, critical sections of a sequential PPS are identified by surrounding boundary instructions (302 and 304), as illustrated in FIG. 2B and FIG. 2C. Representatively, sequential PPS 280 is thread-partitioned into two program-threads (300-1 and 300-2). Once partitioned, execution of the programs threads begins with execution of thread 300-2 (thread one), wherein the variable i 282 is initialized by, for example, an input program. Once initialized, thread-partition 300-1 (thread zero) is notified to begin execution. Once execution of the critical section is complete, thread 300-1 informs thread 300-2. Hence, program-thread 300-1 performs iterations 0, 2, 4, . . . , N of sequential PPS loop 282, whereas program thread 300-2 performs iterations 1, 3, 5, . . . , M of the PPS loop 282

In one embodiment, a level of parallelism is increased by reducing the amount of instructions contained within critical sections. Accordingly, by minimizing critical section code, the amount of code fragments requiring execution in strict sequential thread order is minimized. Once loop carried variables and dependent operations are detected, critical sections are demarcated by boundary instructions. Hence, in one embodiment, preparation work for performing thread-partitioning includes identification of all loop carried variables. In one embodiment, the identification of loop carried variables is performed by an input program and therefore additional details regarding detection of loop carried variables are omitted to avoid obscuring the details of the embodiments of the invention.

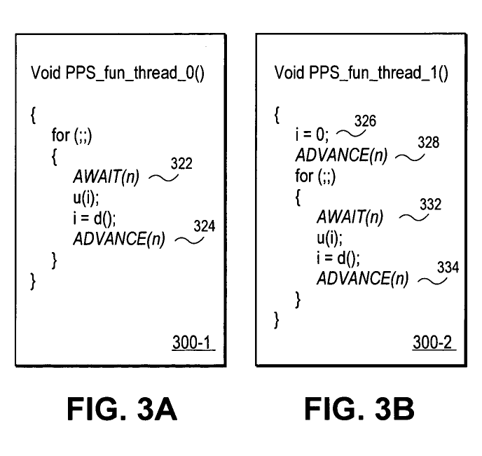

In one embodiment, thread-partitioning compiler 200 (FIG. 1) maintains sequential semantics among program-threads of the sequential application program. In one embodiment, thread-partition compiler introduces synchronization between thread partitions that is sufficient to enforce dependencies between iterations of program-thread loops. In one embodiment, AWAIT operations and ADVANCE operations are provided to perform synchronization, as well as to ensure sequential thread order execution of program-thread-partition loops. Hence, as illustrated with reference to FIGS. 3A-3B, each loop carried variable is assigned within a unique critical section to synchronize access to the loop carried variables in order to form program-thread 300-1 (FIG. 3A) program-thread 300-2 (FIG. 3B).

In the program representations illustrated in FIGS. 3A-3B, a critical section is denoted as N and starts with a special AWAIT(N) operation and ends with an ADVANCE(N) operation. As described herein, an AWAIT instruction refers to an operation that suspends the execution of a current thread until informed by a previous thread on the processing chain to begin execution. As described herein, the term ADVANCE operation refers to operations that notify the next thread on the processing chain to enter a critical section and begin execution thereof. In one embodiment, the boundary instructions (i.e., AWAIT and ADVANCE instructions) synchronize access to loop-carried variables in order to perform execution in strict sequential thread order.

FIG. 4 is a block diagram illustrating a multi-processor, such as, for example, a network processor (NP) 400 configured to provide a multi-threaded architecture. In one embodiment, NP 400 executes program-thread 300-1 and program-thread 300-2 of FIGS. 3A and 3B. In one embodiment, synchronization block 420 performs communication between corresponding ADVANCE and AWAIT instructions. Representatively, program-threads 300-1 and 300-2 are executed in parallel by micro-architecture threads 410 (410-1, . . . , 410-N). Hence, NP 400 executes thread partitions 300-1 and 300-2 formed from a sequential application program. In one embodiment, memory access can be performed concurrently with other operations in order to hide memory access latency by performing thread execution during memory access.

In one embodiment, network processor 400 is, for example, implemented within processor 100 of FIG. 1, such that processor 100 of FIG. 1 implements a multi-threaded micro-architecture. In one embodiment, a general framework of automatic thread partitioning for traditional network packet processing applications may be performed on any computer architecture, including the following features: (1) provides a multi-threaded architecture; (2) provides thread local storage access by each thread exclusively, as well as global storage access by all threads; and (3) provides inter-thread communication and synchronization mechanism signals. Procedural methods for implementing embodiments of the invention are now described.

Operation

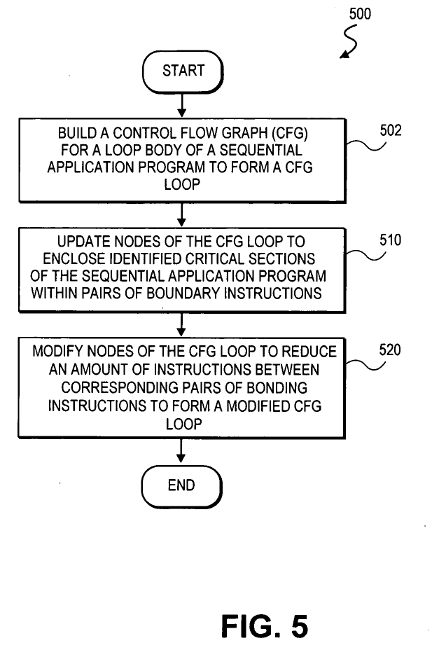

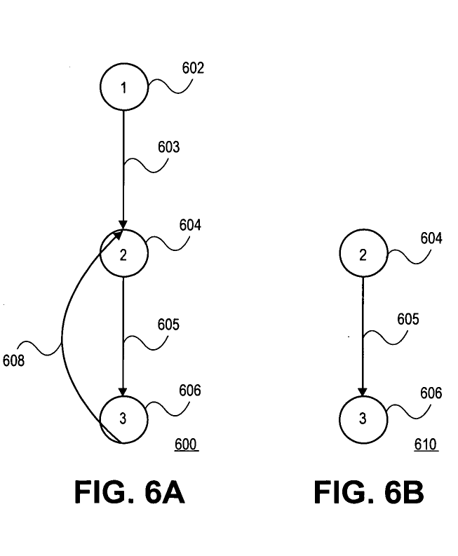

FIG. 5 is a flowchart illustrating a method 500 for thread-partitioning a sequential application program, in accordance with one embodiment of the invention. At process block 502, a control flow graph (CFG) is built for a loop body of a sequential application program to form a CFG loop. As described herein, a CFG is a graph representing the flow of control of the program, where each vertex represents a basic block, and each edge shows the potential flow of control between basic blocks. A control flow graph has a unique source node (entry). In one embodiment, the formation of the CFG loop, as illustrated with reference to FIGS. 6A and 6B.

As illustrated in FIG. 6A, CFG 600 for sequential application 600 includes node 602, node 604 and node 606, as well as back-edge 608. In one embodiment, thread-partitioning is primarily focused on identified PPS loops of a sequential application program. Representatively, a PPS loop body of CFG 600 is comprised of node 604, node 606 and back-edge 608. In one embodiment, a CFG loop 610 is formed, as illustrated in FIG. 6B, by removing node 602, edge 603 and back-edge 608. In one embodiment, CFG loop 610 is used to enable transformation of a PPS loop body of a sequential application program to minimize critical sections.

At process block 510, nodes of the CFG loop are updated to enclose identified critical sections of the sequential application program within pairs of boundary instructions. In one embodiment a pair of AWAIT and ADVANCE operations are initially inserted at a top 604 and a bottom 606 of a CFG loop 610 of FIG. 6B. In one embodiment, AWAIT and ADVANCE operations are viewed as the boundaries of a critical section. At process block 520, nodes of the CFG loop are modified to reduce an amount of instructions between corresponding pairs of boundary instructions to form a modified CFG loop.

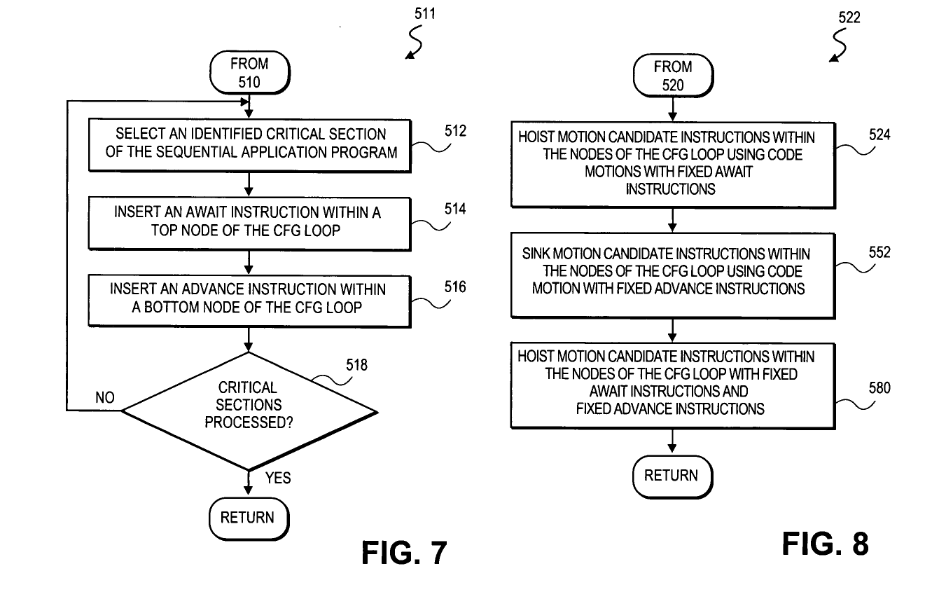

FIG. 7 is a flowchart illustrating a method 511 for updating nodes of the CFG loop of process block 510 of FIG. 5, in accordance with one embodiment of the invention. At process block 512, an identified critical section of the sequential application program is selected. In one embodiment, critical sections of the sequential application program are identified by an input program. As described herein, each identified critical section corresponds to a loop carried variable. In one embodiment, each critical section initially contains all instructions in the PPS loop. Hence, the scope of initial critical section(s) is the whole PPS loop body. Representatively, at process block 514, an AWAIT instruction is inserted within a top node of the CFG loop. Likewise, at process block 516, an ADVANCE instruction is inserted within a bottom node of the CFG loop.

Accordingly, at process block 518, process blocks 514-516 are repeated for each identified critical section of the sequential application program. For example, as illustrated with reference to FIG. 6B, AWAIT operations are inserted within node 604, whereas ADVANCE operations are inserted in node 606. However, the sequential thread order execution requirement of operations between or within critical sections, reduces the amount of parallel execution performed as the amount of operations within critical sections increases. In one embodiment, the amount of code contained within critical sections is minimized to increase parallel execution of program-threads. In one embodiment, code fragments requiring execution in strict sequential thread order are minimized using dataflow analysis, as well as code motion

Accordingly, once each pair of AWAIT and ADVANCE operations are inserted into CFG loop 610 for all identified critical sections of the sequential application program, code motion is performed on the CFG loop to reduce the amount of operations contained within critical sections identified by AWAIT and ADVANCE operations. However, those skilled in the art recognize that code minimization within critical sections may be performed using other data analysis or graph theory techniques, while remaining within the embodiments of the described invention.

As described herein, dataflow analysis is not limited to simply computing definitions and uses of variables (dataflow). Dataflow analysis provides a technique for computing facts about paths through programs or procedures. A prerequisite to the concept of dataflow analysis is the control flow graph (CFG) or simply a flow graph, for example as illustrated with reference to FIG. 6A. A CFG is a directed graph that captures control flow and a part of a program. For example, a CFG may represent a procedure sized program fragment. As described herein, CFG nodes are basic blocks (sections of code always executed in order) and the edges represent possible flow of control between basic blocks. For example, as illustrated with reference to FIG. 6A, control flow graph 600 is comprised of nodes 602-606, as well as edges 603, 605 and back-edge 608.

As described herein, code motion is a technique for inter-block and intra-block instruction reordering (hoisting/sinking). In one embodiment, code motion moves irrelevant code out of identified critical sections in order to minimize the amount of instructions/operations contained therein. To perform the inter-block and intra-block instruction reordering, code motion initially identifies motion candidate instructions. In one embodiment, motion candidate instructions are identified using dataflow analysis. Representatively, a series of dataflow problems are solved to carryout both hoisting and sinking of identified motion candidate instructions.

FIG. 8 is a flowchart of a method 522 for modifying nodes of the CFG loop of process block 520 of FIG. 5, in accordance with one embodiment of the invention. At process block 524, motion candidate instructions are hoisted within the nodes of the CFG loop using code motion with fixed AWAIT boundary instructions. At process block 552, motion candidate instructions are sunk within the nodes of the CFG loop using code motion with fixed ADVANCE operations. At process block 580, motion candidate instructions are hoisted within the nodes of the CFG loop with fixed AWAIT operations and fixed ADVANCE operations. In one embodiment, method 522 represents three-phase code motion to limit operations or reduce the amount of operations bounded by AWAIT and ADVANCE operations, in accordance with one embodiment of the invention.

In one embodiment, a three-phase code motion is used to minimize the amount of operations within identified critical sections of thread-partition loops. Representatively, the first two phases of code motion perform code motion with the AWAIT operations fixed and ADVANCE operations fixed, respectively. As a result, ADVANCE operations are placed into the optimal basic block and AWAIT operations are placed into the optimal basic block. In this embodiment, the last phase of code motion performs code motion with both AWAIT operations and ADVANCE operations fixed. Representatively, this final phase of code motion moves irrelevant instructions out of critical sections, while placing both AWAIT and ADVANCE operations at optimal positions.

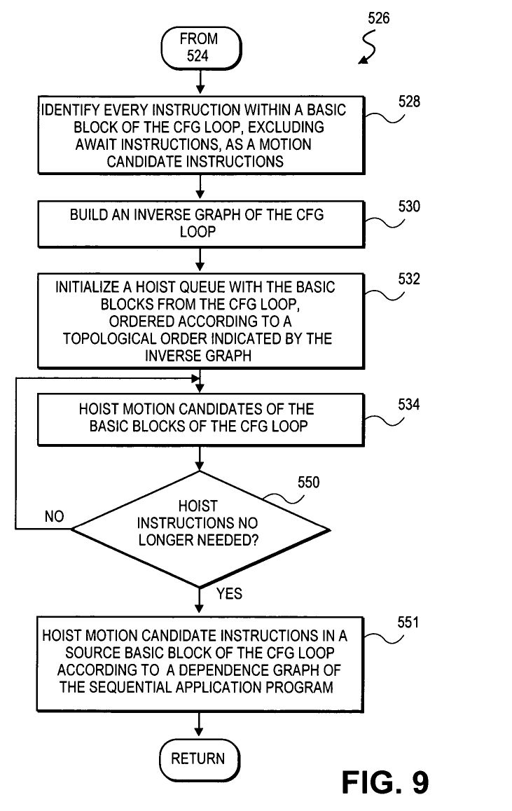

FIG. 9 is a flowchart illustrating a method 526 for hoisting instructions with fixed AWAIT operations of process block 524 of FIG. 8, in accordance with one embodiment of the invention. At process block 528, every instruction within a basic block of the CFG loop is identified as a motion candidate instruction, excluding AWAIT operations. Hence, AWAIT operations are not identified as motion candidate instructions. At process block 530, an inverse graph of the CFG loop is built. At process block 532, a hoist queue is initialized with basic blocks from the CFG loop. In one embodiment, the basic blocks are ordered according to a topological order indicated by the inverse graph.

At process block 550, it is determined whether hoist instructions are no longer detected. Until such is the case, motion candidate instructions are hoisted within the basic blocks of the CFG loop at process block 551. At process block 551, instructions in a source basic block of the CFG loop are hoisted according to a dependence graph of the sequential application program. As descried herein, a dependence graph is constructed to illustrate data dependence of a PPS loop body to provide information about data dependence. Hence, hoisting or sinking any motion candidate instructions cannot violate data dependence on the original program. As descried herein, a dependence graph illustrates data dependence between nodes and control dependence between nodes.

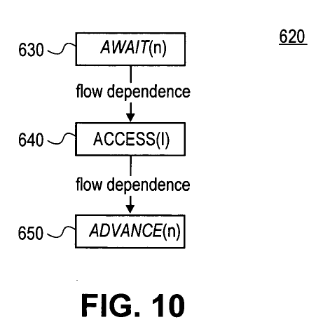

As illustrated with reference to FIG. 10, flow dependence graph 620 illustrates the flow dependence between AWAIT operations 634, accesses operations 640 to within a critical section, such as, for example, loop carried variable i, as well as flow dependence relationship between accesses to loop carried variable i and ADVANCE operations 650. Hence, flow dependence graph 620 ensures that access to loop carried variable i is synchronized by critical section n to enable sequential thread order execution of loop carried variable i.

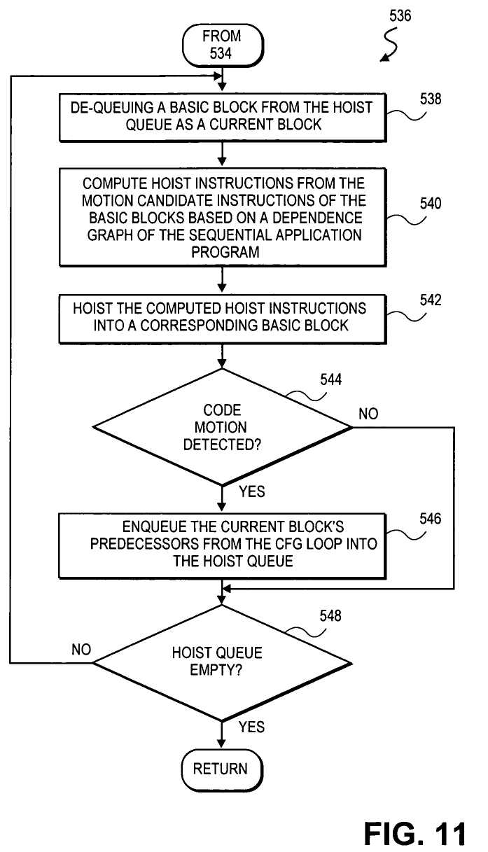

FIG. 11 is a flowchart illustrating a method 536 for hoisting detected hoist instructions within the basic blocks of the CFG loop of process block 534 of FIG. 9, in accordance with one embodiment of the invention. At process block 538, a basic block is de-queued from the hoist queue as a current block. At process block 540, hoist instructions are computed from motion candidate instructions of the basic blocks based on a dependence graph of the sequential application program.

At process block 542, the computed hoist instructions are hoisted into a corresponding basic block into which the computed hoist instruction may be placed. At process block 544, it is determined whether additional code motion is detected, such as for example, a change detected by hoisting of the computed hoist instructions. When a change is detected, at process block 544, the current block's predecessors from the CFG loop are enqueued into the hoist queue at process block 546. At process block 548, process blocks 538-546 are repeated until the hoist queue is empty.

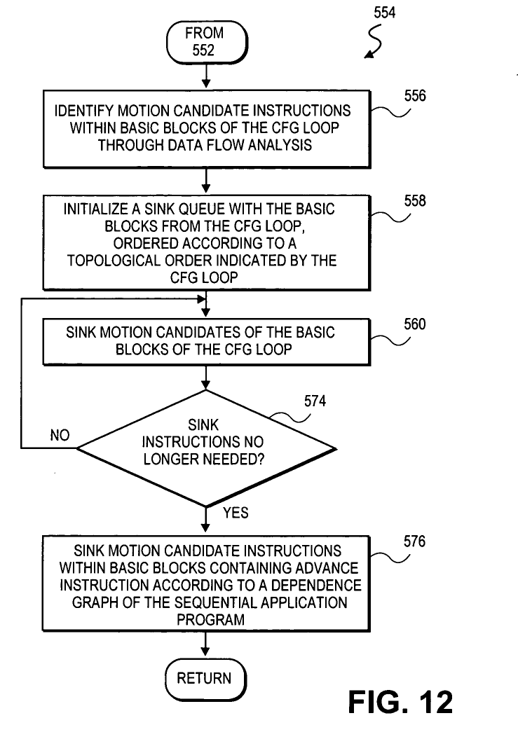

FIG. 12 is a flowchart illustrating a method 554 for sinking detected sink instructions with fixed ADVANCE instructions of process block 552 of FIG. 11, in accordance with one embodiment of the invention. At process block 556, motion candidate instructions within the basic blocks of the CFG loop are identified through dataflow analysis, excluding ADVANCE operations. As referred to above, dataflow analysis identifies hoist instructions, as well as sink instructions, by solving a series of dataflow equations. Dataflow equations are generally formed to establish the truth or falsity of path predicates.

Path predicates are statements about what happens during program execution along a particular control path quantified over all such paths, either universally or existentially. As described herein, a control flow path is a path in the CFG loop. For example, a reaching definitions problem asks for each control flow node n and each variable definition d, whether d might reach n, where reach means the definition gives a value to a variable and the variable is not then redefined. For example, a path predicate may be expressed according to the following equation.
REACHDEF(node n, definition d)=there exists a path p, from start to n, such that d occurs on p, and no definition occurs after d (1)

As described herein, dataflow equations formulate answers to a path predicate as a system of equations describing the solution at each node. That is, for each node in the CFG, we are able to say yes or no regarding whether the definition of interest reaches the node. For example, consider any single three address code statement in the form of:
dᵢ:x:=y op z (2)

This program statement defines the variable x. Accordingly, if such a statement were contained within the node of a control flow graph, as described herein, the node (N) of the control flow graph containing the program statement is set to generate definition dᵢ and kill any other definitions within prior program statements that define x. When analyzed in terms of sets, the following relationships are established:
gen[N]=(dᵢ)
kill[N]=Dx−(dᵢ) (3)
where dx refers to all other definitions of x in the program.

Accordingly, considering a basic block N, figuring out which definitions reach the basic block n requires analysis of predecessors of basic block N. For example, letting the symbol [symbol] represent the predecessor relation on two nodes in a CFG, we say that p is a predecessor of b if there is an edge from p→b in the control flow graph. Accordingly, based on the predecessor relation, the following dataflow equations are generated.

$$in [ B ] = {⋃}_{p ≺ B} out [ P ] \qquad ( 4 )$$

out[B]=gen[B]∪(in[B]−kill[B]) (5)

Accordingly, in order to compute motion candidates through dataflow analysis and in accordance with one embodiment of the invention, for each instruction i the following dataflow equations can be described as follows:
GEN[i]={N|AWAIT(N) if i is AWAIT} (6)
KILL[i]={N|AWAIT(N) if i is ADVANCE} (7)

$$IN [ i ] = {⋃}_{p ∈ Pred ( i )} OUT [ p ] \qquad ( 8 )$$

OUT[i]=GEN[i]∪(IN[i]−KILL[i]) (9)

Accordingly, in one embodiment, motion candidates are computed as follows: (1) AWAITs are identified as motion candidates; (2) an instruction i is a candidate only if IN[i] is not equal to an empty set (0). In other words, for each instruction i, a bit vector is generated according to the dataflow equations in order to determine whether the instruction i is to be identified as a motion candidate. In the embodiment described, ADVANCE operations are not identified as motion candidates.

Referring again to FIG. 12, once motion candidates are identified, at process block 558, a sink queue is initialized with basic blocks of the CFG loop. In one embodiment, the basis blocks are ordered within the sink queue based on a topological order in the CFG loop. At process block 560, motion candidate instructions are sunk among the basing blocks until sinking instructions are no longer detected at process block 574. At process block 576, motion candidate instructions are sunk within basic blocks that contain ADVANCE operations according to the dependence graph of the sequential application program.

In other words, the detection and sinking of sink instructions, as well as hoist instructions, should not violate any data dependencies or, for example, control dependencies, indicated by a dependence graph of the sequential application program. In other words, compliance with a dependence graph ensures that program-threads generated from the sequential application program. In one embodiment, program-threads maintain sequential semantics of the original program and enforce dependencies between program-thread iterations corresponding to a PPS loop of the sequential application program.

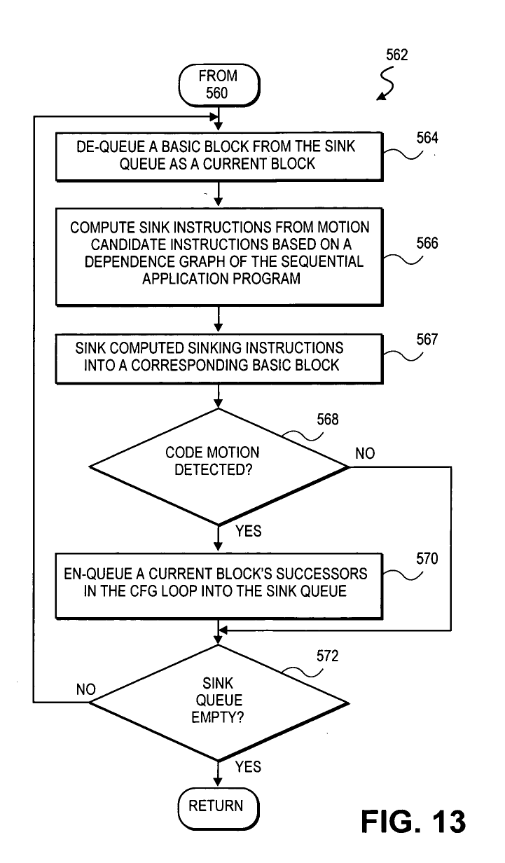

FIG. 13 is a flowchart illustrating a method 562 for sinking motion candidate instructions of process block 560 of FIG. 12, in accordance with one embodiment of the invention. At process block 564, a basic block is de-queued from the sink queue as a current block. At process block 566, sink instructions are computed for motion candidate instructions identified within the basic blocks, based on a dependence graph of the sequential application program, to maintain sequential semantics of the sequential application program. At process block 567, computed sink instructions are sunk into a corresponding basic block. At process block 570, a current block's successors in the CFG loop are enqueued into the sink queue if a code motion change is detected at process block 568, as a result of sinking of computed sink instructions. At process block 572, process blocks 564-570 are repeated until the sink queue is empty.

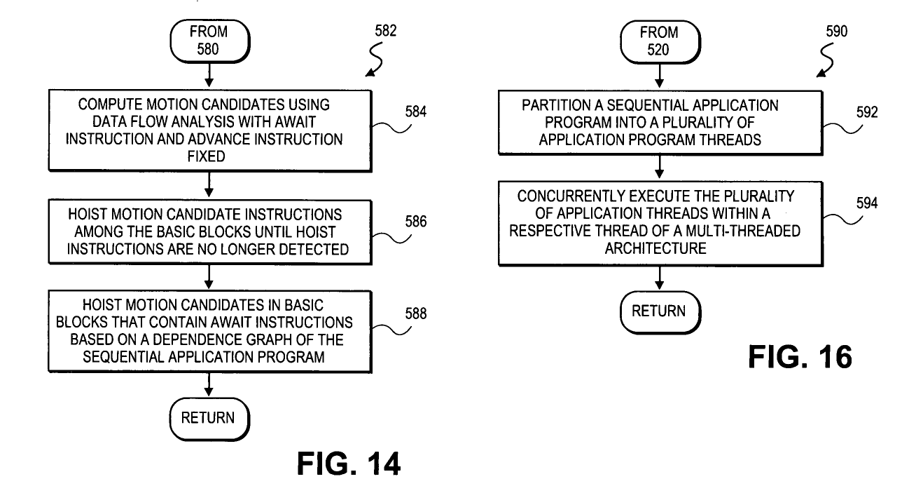

FIG. 14 is a flowchart illustrating a method 582 for hoisting motion candidate instructions with AWAIT instructions and ADVANCE instructions fixed of process block 580 of FIG. 8, in accordance with one embodiment of the invention. At process block 584, motion candidate instructions are detected from the basic blocks using dataflow analysis with AWAIT operations and ADVANCE operations fixed. In one embodiment, motion candidates are computed according to the dataflow analysis described above.

In one embodiment, a host queue is initialized with basic blocks of the CFG loop. In one embodiment, the basic blocks are ordered based on a topological order in the CFG loop. At process block 586, motion candidate instructions are hoisted among the basic blocks until hoist instructions are no longer detected. At process block 588, detected hoist instructions are hoisted within basic blocks that contain AWAIT instructions based on a dependence graph of the sequential application program to preserve the original program order.

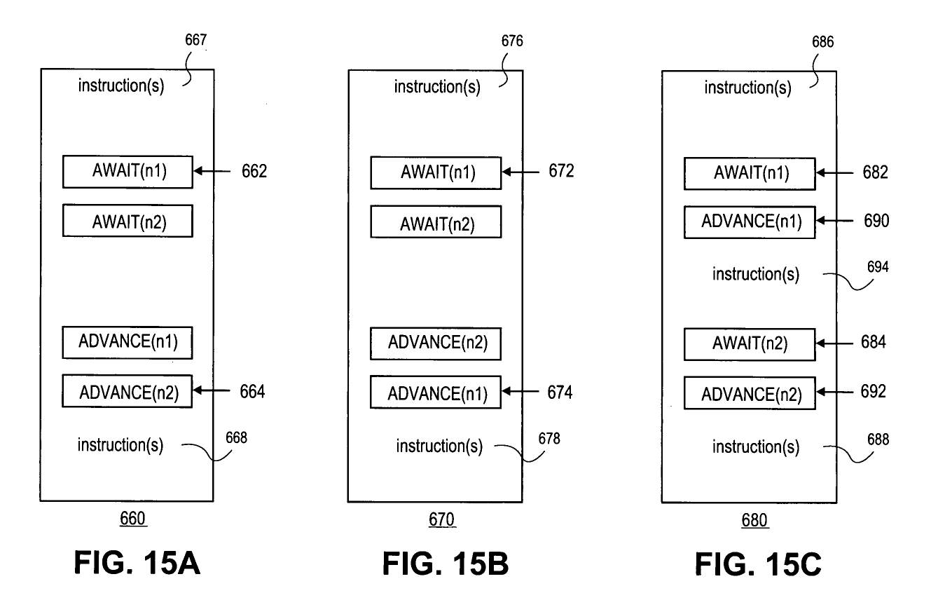

In one embodiment, process block 588 describes intra-block hoisting. In such an embodiment, motion candidates, excluding both AWAIT operations and ADVANCE operations, are hoisted in the basic blocks, which contain AWAIT operations as high as possible without violating the dependence graph. In one embodiment, an instruction is that is hoisted outside of an outmost critical section is no longer regarded as a motion candidate. For example, as illustrated with reference to FIGS. 15A-15C, instructions (667/668), which are hoisted or sunk outside an outmost ADVANCE operation 664 or outmost AWAIT operation 662, are no longer considered as either sink candidates or hoist candidates. Once code motion is performed on the CFG loop, a modified CFG loop is formed, which may be used to form program-threads of a parallel version of the sequential application program.

FIG. 16 is a flowchart illustrating a method 590 for partitioning a sequential application program into a plurality of application program partition threads, in accordance with one embodiment of the invention. At process block 592, the modified control flow graph of process block 520 (FIG. 5) is used to form program-threads of a sequential application program. Once formed, at process block 594, the plurality of program-threads are concurrently executed within a respective thread of a multi-threaded architecture. In one embodiment, concurrent execution of program-threads is illustrated with reference to FIG. 4.

Accordingly, in one embodiment, a thread-partition compiler provides automatic multi-thread transformation of a sequential application program using a three-phase code motion to achieve increased parallelism. Within a multi-threaded architecture, only one thread is alive at any one time. Hence, line rate of a network packet processing stage can be highly improved by hiding memory latency in one thread by overlapping memory access with computations or their memory accesses performed by another thread.

Alternate Embodiments

Several aspects of one implementation of the thread-partition compiler for providing multiple program-threads have been described. However, various implementations of the thread-partition compiler provide numerous features including, complementing, supplementing, and/or replacing the features described above. Features can be implemented as part of the compiler or as part of a hardware/software translation process in different embodiment implementations. In addition, the foregoing description, for purposes of explanation, used specific nomenclature to provide a thorough understanding of the embodiments of the invention. However, it will be apparent to one skilled in the art that the specific details are not required to practice the embodiments of the invention.

In addition, although an embodiment described herein is directed to a thread-partition compiler, it will be appreciated by those skilled in the art that the embodiments of the present invention can be applied to other systems. In fact, data analysis or graph theory techniques for performing code motion within critical sections fall within the embodiments of the present invention, as defined by the appended claims. The embodiments described above were chosen and described to best explain the principles of the embodiments of the invention and its practical applications. These embodiments were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the embodiments of the present invention to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

1. A method comprising:
building a control flow graph (CFG) for a loop body of a sequential application program to form a CFG loop;
updating nodes of the CFG loop to enclose identified critical sections of the sequential application program within pairs of boundary instructions; and
modifying nodes of the CFG loop to reduce an amount of instructions between corresponding pairs of bonding instructions to form a modified CFG loop.

2. The method of claim 1, wherein updating the CFG loop comprises:
selecting an identified critical section of the sequential application program;
inserting an await instruction within a top node of the CFG loop;
inserting an advance instruction within a bottom node of the CFG loop; and
repeating the selecting, inserting and inserting for each identified critical section of the sequential application program.

3. The method of claim 1, wherein modifying nodes of the CFG loop comprises:
hoisting identified motion candidate instructions within the nodes of the CFG loop using code motions with fixed await boundary instructions;
sinking identified motion candidate instructions within the nodes of the CFG loop using code motion with fixed advance instructions; and
hoisting identified motion candidate instructions within the nodes of the CFG loop with fixed await instructions and fixed advance instructions.

4. The method of claim 3, wherein hoisting detected hoist instructions with fixed await instructions comprises:
identifying every instruction within a basic block the CFG loop, excluding await instructions, as a motion candidate instructions;
building an inverse graph of the CFG loop;
initializing a hoist queue with the basic blocks from the CFG loop, the basic blocks ordered according to a topological order indicated by the inverse graph;
hoisting motion candidate instructions of the basic blocks until hoist instructions are no longer detected from the motion candidate instructions; and
hoisting detected hoist instructions from motion candidate instructions in a source basic block of the CFG loop according to a dependence graph of the sequential application program.

5. The method of claim 4, wherein hoisting detected hoist instructions from the motion candidate instructions of the basic blocks comprises:
de-queuing a basic block from the hoist queue as a current block;
computing hoist instructions from the motion candidate instructions of the basic blocks based on a dependence graph of the sequential application program;
hoisting the computed hoist instructions into a corresponding basic block; and
enqueuing the current block's predecessors from the CFG loop into the hoist queue when a change is detected.

6. The method of claim 4, wherein sinking detected sink instructions with fixed advance instructions comprises:
identifying motion candidate instructions within the basic blocks of the CFG loop through dataflow analysis with fixed advance instructions;
initializing a sink queue with the basic blocks ordered based on a topological order in the CFG loop;
sinking detected sink instructions among the basic blocks until sinking instructions are no longer detected; and
sinking detected motion candidates within basic blocks that contain advance instructions according to the dependence graph.

7. The method of claim 6, wherein sinking detected sink instructions among the basis blocks comprises:
de-queue a basic block from the sink queue as a current block;
computing sink instructions from motion candidate instructions based on a dependence graph of the sequential application program;
sinking computed sink instructions into a corresponding basic block; and
en-queuing a current block's successors in the CFG loop into the sink queue if a change is detected.

8. The method of claim 3, wherein performing instruction hoisting with both the await instructions and advance instructions fixed, comprises:
initializing a hoist queue with the basic blocks ordered based on a topological order in the CFG loop;
identifying motion candidate instructions within the basic blocks of the CFG loop through dataflow analysis with fixed advance instructions and fixed await instructions;
hoisting detected hoist instructions among the basic blocks until hoist instructions are no longer detected; and
hoist motion candidates within basic blocks that contain await instructions based on a dependence graph of the sequential application program.

9. The method of claim 8, wherein motion candidate instructions hoisted out of an outmost await instruction are no longer treated as motion candidates; and
wherein motion candidate instructions out of an outmost advance instruction are no longer treated as motion candidates.

10. The method of claim 1, further comprising:
forming a plurality of application program thread partitions from the modified CFG loop; and
concurrently executing the plurality of application program threads within a respective thread of a multi-threaded architecture.

11. An article of manufacture including a machine readable medium having stored thereon instructions which may be used to program a system to perform a method, comprising:
building a control flow graph (CFG) for a loop body of a sequential application program to form a CFG loop;
updating nodes of the CFG loop to enclose identified critical sections of the sequential application program within pairs of boundary instructions; and
modifying nodes of the CFG loop to reduce an amount of instructions between corresponding pairs of bonding instructions to form a modified CFG loop.

12. The article of manufacture of claim 11, updating the CFG loop comprises:
selecting an identified critical section of the sequential application program;
inserting an await instruction within a top node of the CFG loop;
inserting an advance instruction within a bottom node of the CFG loop; and
repeating the selecting, inserting and inserting for each identified critical section of the sequential application program.

13. The article of manufacture of claim 11, wherein modifying nodes of the CFG loop comprises:
hoisting identified motion candidate instructions within the nodes of the CFG loop using code motions with fixed await boundary instructions;
sinking identified motion candidate instructions within the nodes of the CFG loop using code motion with fixed advance instructions; and
hoisting identified motion candidate instructions within the nodes of the CFG loop with fixed await instructions and fixed advance instructions.

14. The article of manufacture of claim 13, wherein hoisting detected hoist instructions with fixed await instructions comprises:
identifying every instruction within a basic block the CFG loop, excluding await instructions, as a motion candidate instructions;
building an inverse graph of the CFG loop;
initializing a hoist queue with the basic blocks from the CFG loop, the basic blocks ordered according to a topological order indicated by the inverse graph;
hoisting motion candidate instructions of the basic blocks until hoist instructions are no longer detected from the motion candidate instructions; and
hoisting detected hoist instructions from motion candidate instructions in a source basic block of the CFG loop according to a dependence graph of the sequential application program.

15. The article of manufacture of claim 14, wherein hoisting detected hoist instructions from the motion candidate instructions of the basic blocks comprises:
de-queuing a basic block from the hoist queue as a current block;
computing hoist instructions from the motion candidate instructions of the basic blocks based on a dependence graph of the sequential application program;
hoisting the computed hoist instructions into a corresponding basic block; and
enqueuing the current block's predecessors from the CFG loop into the hoist queue when a change is detected.

16. The article of manufacture of claim 14, sinking detected sink instructions with fixed advance instructions comprises:
identifying motion candidate instructions within the basic blocks of the CFG loop through dataflow analysis with fixed advance instructions;
initializing a sink queue with the basic blocks ordered based on a topological order in the CFG loop;
sinking detected sink instructions among the basic blocks until sinking instructions are no longer detected; and
sinking detected motion candidates within basic blocks that contain advance instructions according to the dependence graph.

17. The article of manufacture of claim 16, wherein sinking detected sink instructions among the basis blocks comprises:
de-queue a basic block from the sink queue as a current block;
computing sink instructions from motion candidate instructions based on a dependence graph of the sequential application program;
sinking computed sink instructions into a corresponding basic block; and
en-queuing a current block's successors in the CFG loop into the sink queue if a change is detected.

18. The article of manufacture of claim 13, wherein performing instruction hoisting with both the await instructions and advance instructions fixed, comprises:
initializing a hoist queue with the basic blocks ordered based on a topological order in the CFG loop;
identifying motion candidate instructions within the basic blocks of the CFG loop through dataflow analysis with fixed advance instructions and fixed await instructions;
hoisting detected hoist instructions among the basic blocks until hoist instructions are no longer detected; and
hoist motion candidates within basic blocks that contain await instructions based on a dependence graph of the sequential application program.

19. The article of manufacture of claim 18, wherein motion candidate instructions hoisted out of an outmost await instruction are no longer treated as motion candidates; and
wherein motion candidate instructions out of an outmost advance instruction are no longer treated as motion candidates.

20. The article of manufacture of claim 11, further comprising:
forming a plurality of application program thread partitions from the modified CFG loop; and
concurrently executing the plurality of application program threads within a respective thread of a multi-threaded architecture.

21. A method comprising:
partitioning a sequential application program into a plurality of application program threads; and
concurrently executing the plurality of application program threads within a respective thread of a multi-threaded architecture.

22. The method of claim 21, wherein partitioning the sequential application program comprises:
determining a thread count of a multi-threaded architecture;
receiving identified critical sections within the sequential application program; and
generating a plurality of application program threads according to the thread count to synchronize access to identified critical sections among the plurality of application program threads.

23. The method of claim 21, wherein concurrently executing further comprises:
executing each iteration of a thread program loop by distinct multi-threaded architecture; and
executing critical sections of the thread program loop sequential thread order.

24. The method of claim 22, wherein generating the application program threads comprises:
processing identified critical sections to reduce an amount of code contained within critical sections of thread program loops.

25. The method of claim 24, wherein code motion is used to reduce the amount of code contained within critical sections of the thread program loops.

26. An article of manufacture including a machine readable medium having stored thereon instructions which may be used to program a system to perform a method, comprising:
partitioning a sequential application program into a plurality of application program threads; and
concurrently executing the plurality of application program threads within a respective thread of a multi-threaded architecture.

27. The article of manufacture of claim 26, wherein partitioning the sequential application program comprises:
determining a thread count of a multi-threaded architecture;
receiving identified critical sections within the sequential application program; and
generating a plurality of application program threads according to the thread count to synchronize access to identified critical sections among the plurality of application program threads.

28. The article of manufacture of claim 26, wherein concurrently executing further comprises:
executing each iteration of a thread program loop by distinct multi-threaded architecture; and
executing critical sections of the thread program loop sequential thread order.

29. The article of manufacture of claim 27, wherein generating the application program threads comprises:
processing identified critical sections to reduce an amount of code contained within critical sections of thread program loops.

30. The article of manufacture of claim 29, wherein code motion is used to reduce the amount of code contained within critical sections of the thread program loops.

31. An apparatus, comprising:
a processor;
a memory coupled to the processor, the memory including a compiler to cause a partition a sequential application program into a plurality of application program-threads to enable concurrent execution of the plurality of program-threads within a respective thread of a multi-threaded architecture.

32. The apparatus of claim 31, wherein the compiler to cause building a control flow graph (CFG) for a loop body of a sequential application program to form a CFG loop to cause an update of nodes of the CFG loop to enclose identified critical sections of the sequential application program within pairs of boundary instructions and to cause modification of nodes of the CFG loop to reduce an amount of instructions between corresponding pairs of bonding instructions to form a modified CFG loop.

33. The apparatus of claim 32, wherein the compiler to cause hoisting identified motion candidate instructions within the nodes of the CFG loop using code motions with fixed await boundary instructions, to cause sinking of identified motion candidate instructions within the nodes of the CFG loop using code motion with fixed advance instructions and to cause hoisting of motion candidate instructions within the nodes of the CFG loop with fixed await instructions and fixed advance instructions.

34. A system comprising:
a processor;
a memory controller coupled to the processor; and
a DDR SRAM memory coupled to the processor, the memory including a compiler to cause partitioning a sequential application program into a plurality of application program threads to enable concurrent execution of the plurality of application program threads within a respective thread of a multi-threaded architecture

35. The system of claim 34, wherein the compiler to cause building a control flow graph (CFG) for a loop body of a sequential application program to form a CFG loop to cause an update of nodes of the CFG loop to enclose identified critical sections of the sequential application program within pairs of boundary instructions and to cause modification of nodes of the CFG loop to reduce an amount of instructions between corresponding pairs of bonding instructions to form a modified CFG loop.

36. The system of claim 35, wherein the compiler to cause hoisting identified motion candidate instructions within the nodes of the CFG loop using code motions with fixed await boundary instructions, to cause sinking of identified motion candidate instructions within the nodes of the CFG loop using code motion with fixed advance instructions and to cause hoisting of motion candidate instructions within the nodes of the CFG loop with fixed await instructions and fixed advance instructions.
